(19) United States
(12) Patent Application Publication
(10) Pub. No.: US 2025/0263846 A1
(43) Pub. Date: Aug. 21, 2025

(54) WATER ELECTROLYSIS STACK

(71) Applicant: TOYOTA JIDOSHA KABUSHIKI KAISHA, Toyota-shi (JP)

(72) Inventors: Hikaru HASEGAWA, Numazu-shi (JP); Satoshi AOYAMA, Susono-shi (JP); Takashi KAJIWARA, Susono-shi (JP); Keiji TOYODA, Toyota-shi (JP)

(21) Appl. No.: 19/042,155

(22) Filed: Jan. 31, 2025

(30) Foreign Application Priority Data
Feb. 19, 2024 (JP) 2024-022608

(51) Int. Cl. C25B 1/04; C25B 9/60; C25B 9/70; C25B 11/032

(52) U.S. Cl. CPC C25B 1/04; C25B 9/60; C25B 9/70; C25B 11/032

(57) ABSTRACT

To provide a water electrolysis stack capable of suppressing deterioration in sealability. A water electrolysis stack configured by laminating a plurality of water electrolysis cells to generate hydrogen by supplying water to the water electrolysis cell and applying electric power, wherein a laminated member for improving sealing property, which is a member that does not introduce water therein, is laminated at a predetermined position of the water electrolysis cell to be laminated.

### FIELD

The present disclosure relates to a water electrolysis stack in which a water electrolysis cell is laminated.

### BACKGROUND

In Patent Document 1, it is required to supply hydrogen generated by water electrolysis by increasing pressure in a water electrolysis stack, and a high pressure-resistant structure of a seal member at an end portion in a planar direction of a water electrolysis cell is disclosed.

### CITATION LIST

### Patent Literature

[Patent Document 1] JP 2019-123906 A

### SUMMARY

### Technical Problem

In the water electrolysis stack, with an increase in the internal pressure of the hydrogen electrode, the central portion bulges in a plurality of water electrolysis cells arranged between the end plates as shown in FIG. 16, warpage increases in the water electrolysis cells arranged on the most end plate side, deformed as surrounded by dotted circles, there is a possibility that the sealing property by the disposed sealing member of this end portion is lowered. Such a decrease in sealability may not sufficiently increase the hydrogen pressure, or may cause hydrogen leakage.

In view of the above problems, it is an object of the present disclosure to provide a water electrolysis stack capable of suppressing deterioration in sealability.

### Solution to Problem

The present application discloses a water electrolysis stack that is configured by laminating a plurality of water electrolysis cells and generates hydrogen by supplying water to the water electrolysis cells and applying electric power, wherein a laminated member for improving sealing property is laminated at a predetermined position of the water electrolysis cells to be laminated, the laminated member for improving sealing property, which is a member that does not introduce water therein.

Sealability improving stacking member, the first outer body is the same shape as the anode separator water electrolysis cell comprises, the second outer body is the same shape as the cathode separator water electrolysis cell comprises, a core material disposed between the first outer body and the second outer body, and the first outer body and the second outer body It is disposed between the frame for bonding the first outer body and the second outer body, it may be configured to have a.

It may be configured to have a communicating hole for communicating the space and the outside between the first outer body and the second outer body.

The communicating hole may be provided in at least one of the first exterior body or the second exterior body.

A communicating hole may be provided in the frame.

A communicating hole may be formed between the first exterior body or the second exterior body and the frame.

The core material may be composed of the same material as the cathode gas diffusion layer of the water electrolysis cell.

Sealability improving stacking member may be disposed at an end portion of the laminate by the water electrolysis stack.

The laminated member for improving the sealing property may be a plate-like member hardly bent than the water electrolysis cell.

This laminate member for improving sealability may be disposed between a plurality of water electrolysis stacks.

### Advantageous Effects

According to the present disclosure, by the laminated member for improving the sealing property, it is possible to reduce the water electrolysis cell having a large deformation, it is possible to suppress a decrease in the sealing property in the water electrolysis stack.

### BRIEF DESCRIPTION OF DRAWINGS

FIG. 1 is a plan view of the water electrolysis cell 10.

FIG. 2 is a conceptual diagram illustrating the layered structure of the water electrolysis cell 10 10a the water electrolysis area.

FIG. 3 is a conceptual diagram illustrating a layered configuration at a site of an oxygen electrode deriving-side distribution region 10d and an oxygen electrode deriving region 10e of the water electrolysis cell 10.

FIG. 4 is a conceptual diagram illustrating the structure of the water electrolysis stack 30.

FIG. 5 is a diagram illustrating a laminated structure of the water electrolysis cell 10 in the water electrolysis stack 30.

FIG. 6 is another view illustrating a laminated structure of the water electrolysis cell 10 in the water electrolysis stack 30.

FIG. 7 is a conceptual diagram illustrating the structure of the water electrolysis stack 40.

FIG. 8 is a view of a plan view of the sealability improving stacking member 41.

FIG. 9 is a cross-sectional view of the sealability improving stacking member 41.

FIG. 10 is another cross-sectional view of the sealability improving stacking member 41.

FIG. 11 is a diagram for explaining a modification 1 of the sealability improving stacking member 41.

FIG. 12 is a diagram illustrating a second modification of the stack member 41 for improving the sealability.

FIG. 13 is a diagram for explaining a third modification of the sealability improving stacking member 41.

FIG. 14 is a conceptual diagram illustrating the structure of the water electrolysis stack 50.

FIG. 15 is a view of a plan view of the sealability improving stacking member 51.

FIG. 16 is a diagram for explaining the warpage of the water electrolysis cell in the water electrolysis stack.

### DESCRIPTION OF EMBODIMENTS

### 1. Basic Configuration of the Water Electrolysis Stack

The water electrolysis stack of the present disclosure is characterized in that a laminated member for improving sealability is arranged. First, the basic configuration included in the water electrolysis stack is a target in which the laminated member for improving sealing property is arranged. The sealability improving stacking member and the water electrolysis stack this is disposed will be described thereafter.

### 1.1. Water Electrolysis Cell

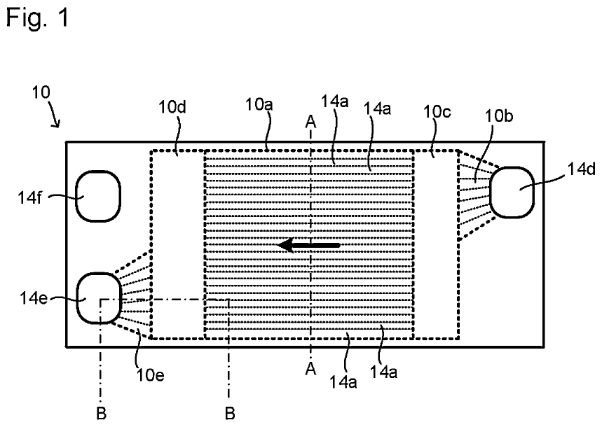

In a water electrolysis stack, a plurality of water electrolysis cells are stacked and form a main part. FIG. 1 shows a diagram illustrating the structure of the water electrolysis cell 10 according to one embodiment. The water electrolysis cell 10 is a unit element for decomposing pure water into hydrogen and oxygen, and a plurality of such water electrolysis cells 10 are laminated to constitute a water electrolysis stack. FIG. 1 is a plan view of the water electrolysis cell 10 (the stacking direction of the plurality of water electrolysis cells 10 in the plane of the paper/front direction). In FIG. 1, in order to explain the internal structure of the water electrolysis cell 10, a portion of the internal structure (particularly, the oxygen electrode side) is represented by a dotted line.

Water electrolysis in the water electrolysis cell 10 is as known, but the outline thereof is as follows.

Pure water flows into the oxygen electrode introduction area 10b from the oxygen electrode introduction hole (oxygen electrode-side inlet manifold) 14d. Thereafter, the pure water reaches the water electrolysis region 10a after the uniformity of the distribution is enhanced in the oxygen-electrode introduction-side distribution region 10c, where water electrolysis is performed. However, water electrolysis may be performed even in the oxygen-electrode introduction-side distribution area 10c.

In the water electrolysis area 10a, a portion of pure water is decomposed into oxygen and hydrogen by a water electrolysis membrane electrode assembly to be described later, and is discharged through the respective flow paths. Oxygen generated and residual pure water is collected by the oxygen electrode lead-out flow path 10e through the oxygen electrode lead-out side distribution area 10d and discharged from the oxygen electrode lead-out hole (oxygen electrode side outlet manifold) 14e.

On the other hand, the generated hydrogen is transferred to the electrode (hydrogen electrode) opposite to the electrode (oxygen electrode) through which pure water flows across the water electrolytic membrane electrode assembly, and is discharged from the hydrogen electrode lead-out hole (hydrogen electrode side outlet manifold) 14f through another channel (not shown) Both of the oxygen electrode and the hydrogen electrode are provided in the water electrolysis cell 10, but other than the water electrolysis area 10a, a respective flow path separated from each other is formed so as to be partitioned by a sealing member (not shown) so that the generated hydrogen and oxygen do not mix.

It is to be noted that, similarly to the unit cell of the fuel cell, another pair of manifolds may be arranged for flowing a fluid between adjacent water electrolysis cells, and it is desirable to flow hydrogen generated here at this time.

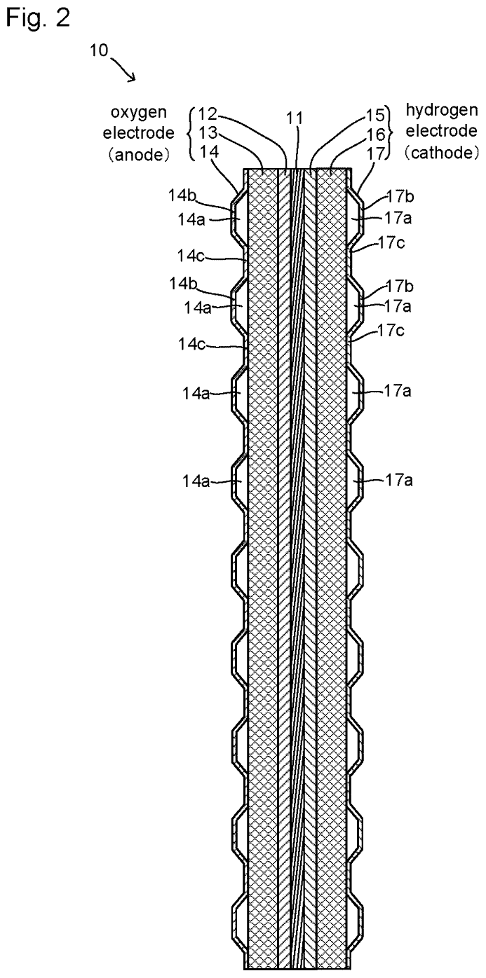

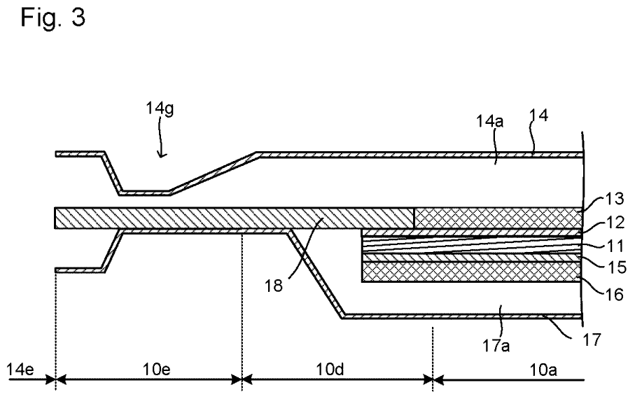

Hereinafter, a configuration of the water electrolysis cell 10 will be described. FIG. 2 is a view for explaining a layered structure in the water electrolysis area 10a which is a part of the A-A cross section of FIG. 1 and in which water electrolysis is mainly performed in the water electrolysis cell 10. FIG. 3 is a B-B cross-section of FIG. 1, showing a portion of the oxygen electrode lead-out hole (oxygen electrode side outlet manifold) 14e, the oxygen electrode lead-out region 10e, the oxygen electrode lead-out side distribution region 10d, and a layer configuration of a portion of the water electrolysis region 10a.

The water electrolysis cell 10 is composed of a plurality of layers, and one of them becomes an oxygen electrode (anode) and the other becomes a hydrogen electrode (cathode) with the solid polymer electrolyte membrane 11 sandwiched therebetween.

In the water electrolysis area 10a, as shown in FIG. 2, the anode is laminated in this order from the solid polymer electrolyte membrane 11 side to the anode catalyst layer 12, the anode gas diffusion layer 13, and the anode separator 14. On the other hand, the cathode includes a cathode catalyst layer 15, a cathode gas diffusion layer 16, and a cathode separator 17 in this order from the side of the solid polymer electrolyte membrane 11 Here, the water electrolyte membrane electrode assembly means a stack of a solid polymer electrolyte membrane 11, an anode catalyst layer 12 disposed on an anode side of the solid polymer electrolyte membrane 11, and a cathode catalyst layer 15 disposed on a cathode side of the solid polymer electrolyte membrane 11 The thickness of the water electrolysis membrane electrode assembly is typically about 0.4 mm, and the thickness of the water electrolysis cell 10 in the water electrolysis area 10a is typically about 1.3 mm At both ends of the water electrolysis area 10a of the water electrolysis cell 10, a frame 18 is provided as shown in FIG. 3.

First, an embodiment of each layer will be described, and then a layer configuration in each region will be described.

### 1.1.1. Aspect of Each Layer

Each layer provided in the water electrolysis cell 10 has, for example, the following aspect. However, the water electrolysis cell of the present disclosure is not limited to the embodiment.

### Solid Polymer Electrolyte Membrane

The solid polymer electrolyte membrane 11 is an embodiment of an electrolyte membrane having proton conductivity. The material (electrolyte) constituting the solid polymer electrolyte membrane 11 in this form is a solid polymer material, and examples thereof include a proton conductive ion exchange membrane formed of a fluorine-based resin, a hydrocarbon-based resin material, or the like. It exhibits good proton conductivity (electrical conductivity) in the wet state. More specific examples thereof include a membrane made of Nafion (Nafion, registered trademark) which is a perfluoro-based electrolyte.

The thickness of the solid polymer electrolyte membrane 11 is not particularly limited, but is 200 μm or less, preferably 100 μm or less, and more preferably 30 μm or less.

### Anode Catalyst Layer

The anode catalyst layer (oxygen electrode catalyst layer) 12 is a catalyst layer having a catalyst containing at least one or more of a noble metal catalyst such as Pt, Ru, Ir and an oxide thereof. More specific examples of the catalyst include Pt, iridium oxide, ruthenium oxide, iridium ruthenium oxide, or mixtures thereof.

Examples of the iridium oxide include iridium oxide (IrO₂, IrO₃), iridium tin oxide, and iridium zirconium oxide.

Examples of the ruthenium oxide include ruthenium oxide (RuO₂, Ru₂O₃), ruthenium tantalum oxide, ruthenium zirconium oxide, ruthenium titanium oxide, and ruthenium titanium cerium oxide.

Examples of the iridium ruthenium oxide include iridium ruthenium cobalt oxide, iridium ruthenium tin oxide, iridium ruthenium iron oxide, and iridium ruthenium nickel oxide.

The anode catalyst layer 12 may include an ionomer. In addition to improving coatability by including an ionomer, transmission of water supplied during water splitting can be smoothly performed due to its hydrophilicity. Examples of the ionomer to be included include an ionomer containing a perfluoro electrolyte which is an electrolyte used in a solid polymer electrolyte membrane.

### Anode Gas Diffusion Layer

The anode gas diffusion layer 13 is a gas diffusion layer disposed on the anode side, it is possible to use known ones, is constituted by a member having a gas permeability and conductivity. Specific examples thereof include a porous conductive member made of a sintered body such as metal fibers (e.g., titanium fibers) or metal particles (titanium particles)

### Anode Separator

The anode separator 14 is a member (separator) including a channel (water supply channel) 14a through which pure water, decomposed oxygen, and residual water to be supplied to the anode gas diffusion layer 13 flow. The anode separator 14 in this embodiment is a member unevenness is repeated to form a plate-like member in the water electrolysis area 10a is arranged in contact with the anode gas diffusion layer 13 recess 14c, the anode gas diffusion layer 13 and the convex portion between 14b water supply flow path 14a is formed.

Anode separator 14 can be made by, for example, press molding a titanium thin film, the plate thickness is typically 0.1 mm˜0.2 mm, the height of the unevens is typically 0.5 mm degree.

Further, the anode separator 14, as shown in FIG. 1 and described above, the oxygen electrode side inlet manifold 14d is an inlet of pure water, the oxygen electrode side outlet manifold 14e is a discharge port of oxygen and remaining water generated, and the hydrogen electrode side outlet manifold 14f is a discharge port of hydrogen and accompanying water generated is provided.

Further, as shown in FIG. 3, the anode separator 14 of the present embodiment, the oxygen electrode lead-out area 10e, the squeezed portion 14g is provided so as to be convex toward the cathode separator 17.

In addition, in the present embodiment, a groove may be provided on a surface of the anode separator 14 which becomes the cathode separator 17 side in the oxygen electrode lead-out side distribution region 10d and the oxygen electrode lead-out region 10e successive thereto.

In addition, in the front and back of the anode separator 14, a conductive layer may be provided at a portion corresponding to the water-electrolyzed region 10a in order to reduce the electric contactresistance. The material constituting the conductive layer may be any material having conductivity, and examples thereof include platinum.

### Cathode Catalyst Layer

The cathode catalyst layer 15 is a catalyst layer containing a catalyst, and a catalyst contained in the cathode catalyst layer 15 may be a known catalyst, and examples thereof include platinum, platinum coated titanium, platinum supported carbon, palladium supported carbon, cobalt trioxime, and nickel glyoxime.

The cathode catalyst layer 15 may include an ionomer. By including an ionomer, coatability can be improved. Examples of the ionomer to be included include an ionomer comprising a perfluoro electrolyte which is an electrolyte used in a solid polymer electrolyte membrane.

### Cathode Gas Diffusion Layer

Cathode gas diffusion layer 16 is a gas diffusion layer disposed on the cathode side, it is possible to use known ones, is constituted by a member having a gas permeability and conductivity. Specific examples thereof include porous members such as carbon cloth and carbon paper.

### Cathode Separator

The cathode separator 17 is a member including a channel 17a through which hydrogen ions generated by reduction of hydrogen ions and water (accompanying water) accompanying the hydrogen ions permeate through the solid polymer electrolyte membrane 11 reach. Cathode separator 17 in this embodiment is a member unevenness is repeated to form a plate-like member in the water-electrolysis area 10a is placed in contact with the cathode gas diffusion layer 16, the cathode gas diffusion layer 16 and the convex portion 17b flow path 17a for hydrogen discharge is formed between.

The cathode separator 17 can be manufactured, for example, by press-molding a titanium thin film, and the plate thickness thereof is typically 0.1 mm˜0.2 mm, and the height of the unevenness is typically about 0.5 mm

Further, the cathode separator 17, as shown in FIG. 1 and described above, the oxygen electrode side inlet manifold overlapping the oxygen electrode side inlet manifold 14d (not shown), the oxygen electrode side outlet manifold overlapping the oxygen electrode side outlet manifold 14e described above (not shown), and the hydrogen electrode side outlet manifold overlapping the hydrogen electrode side outlet manifold 14f (not shown) is provided.

Among the front and back surfaces of the cathode separator 17, a conductive layer may be provided at a portion corresponding to the water-electrolyzed region 10a in order to reduce the electric contactresistance. The material constituting the conductive layer may be any material having conductivity, and examples thereof include platinum.

### Frame

Frame 18 is disposed between the anode separator 14 and the cathode separator 17 in the outer peripheral portion of the water electrolysis cell 10 to seal the inside, and functions as a sealing member for sealing so as to form a required flow path by separating the oxygen electrode side and the hydrogen electrode side.

Accordingly, the frame 18 surrounds the water electrolysis region 10a, the oxygen electrode introduction region 10b, the oxygen electrode introduction side dispersion region 10c, the oxygen electrode derivation side dispersion region 10d, the oxygen electrode derivation region 10e, and the like, and is disposed so as to be sandwiched between the anode separator 14 and the cathode separator 17

Frame 18, for example, in the cross-section of FIG. 3, from the water supply flow path 14a of the anode separator 14 oxygen electrode leading side distribution region 10d, since flowing oxygen and residual water generated in the oxygen electrode side outlet manifold 14e through the oxygen electrode leading region 10e is not sealed in the part. On the other hand, in the cross-section of FIG. 3, the flow of hydrogen from the flow path 17a of the cathode separator 17 to the oxygen-electrode-side inlet manifold 14e is sealed so as to be blocked. Thus, the frame 18 is adjusted in contact (seal) with the anode separator 14 and cathode separator 17 so that the fluid flow is adequate.

The frame 18 is made of a thermoplastic resin material having electrical insulation and airtightness and having a relatively high melting point. Such materials may include engineering plastics. Examples of the engineering plastic include a polyethylene naphthalate-based resin (PEN), a polyphenylene sulfide resin (PPS), and a polyphenylsulfone resin (PPSU)

The thickness of the frame is not particularly limited, but is preferably 0.05 mm or more and 0.25 mm or less.

An adhesive is disposed on the front and rear sides of the frame 18, and a portion of the anode separator 14 and a portion of the cathode separator 17 in contact therewith are bonded thereto.

### 1.1.2. Layer Configuration in the Water Electrolysis Region

As shown in FIG. 2, the layer structure of the water electrolysis area 10a is such that the anode is laminated in this order from the side of the solid polymer electrolyte membrane 11 to the anode catalyst layer 12, the anode gas diffusing layer 13, and the anode separator 14. On the other hand, the cathode includes a cathode catalyst layer 15, a cathode gas diffusion layer 16, and a cathode separator 17 in this order from the side of the solid polymer electrolyte membrane 11

The anode separator 14 includes a channel (water supply channel) 14a through which pure water and decomposed oxygen are supplied to the anode gas diffusion layer 13 In this embodiment, the anode separator 14 forms a plate-like member in a wavy shape in the water electrolysis area 10a and unevens are repeated, by the recess 14c is disposed in contact with the anode gas diffusion layer 13, the anode gas diffusion layer 13 and the water supply flow path 14a is formed between the convex portion 14b.

The cathode separator 17 includes a channel 17a in which hydrogen ions generated by reduction of hydrogen ions and water (accompanying water) accompanying the hydrogen ions reach when the hydrogen ions permeate through the solid polymer electrolyte membrane 11, and in the present embodiment, the cathode separator 17 forms a plate-like member in the water electrolysis region 10a in a wavy manner, and unevens are repeated, and the concave 17c is disposed in contact with the cathode gas diffusion layer 16 to form a channel 17a for hydrogen discharge between the cathode gas diffusion layer 16 and the convex portion 17b

### 1.1.3. Composition of Other Regions

Other regions include an oxygen electrode introduction region 10b, an oxygen electrode introduction side distribution region 10c, an oxygen electrode derivation side distribution region 10d, an oxygen electrode derivation region 10e, a hydrogen electrode derivation side distribution region (not shown), and a hydrogen electrode derivation region. The oxygen electrode deriving-side distribution region 10d and the oxygen electrode deriving region 10e shown in FIGS. 1 and 3 will be exemplified here.

The oxygen electrode derivation side distribution region 10d and the oxygen electrode derivation region 10e are regions through which oxygen and residual water generated in the water electrolysis region 10a pass by the time they are discharged into the oxygen electrode side outlet manifold 14e.

In the oxygen electrode deriving-side distribution area 10d, as can be seen from FIG. 3, the solid polymer electrolyte membrane 11, the anode catalyst layer 12, the anode gas diffusion layer 13, the cathode catalyst layer 15, and the end face of the cathode gas diffusion layer 16 are formed. Here, the end face of the anode gas diffusion layer 13 is formed at a position slightly retracted compared to the other end face. Then, it is laminated to the anode catalyst layer 12, the frame 18 is disposed so as to extend from the end face of the anode gas diffusion layer 13. The frame 18 is provided to extend into the oxygen electrode lead-out area 10e and to the oxygen electrode outlet manifold 14e. Further, the cathode separator 17 in the oxygen-electrode lead-side distribution area 10d is bent in the thickness direction (stacking direction of each layer) until it contacts the surface of the frame 18, the hydrogen-electrode side is sealed.

In the oxygen-electrode lead-out area 10e, the diaphragm 14g is formed so that the anode separator 14 is bent so as to approach the frame 18, and the flow passage is narrowed in the thickness direction. However, there is formed a flow path leading to the oxygen electrode outlet manifold 14e with a predetermined spacing since the generated oxygen and residual water needs to flow.

Although the oxygen electrode introduction region 10b and the oxygen electrode introduction side distribution region 10c differ in the direction in which the fluid flows, the oxygen electrode introduction region 10b can be considered similarly to the oxygen electrode lead-out region 10e, and the oxygen electrode introduction side distribution region 10c can be considered similarly to the oxygen electrode lead-out side distribution region 10d.

The hydrogen electrode deriving side distribution region and the hydrogen electrode deriving region are regions in which a flow path is formed for guiding hydrogen and accompanying water generated on the hydrogen electrode side from the water electrolysis region 10a to the hydrogen side outlet manifold 14f The configuration of these regions, the oxygen electrode lead-out side distribution region 10d form above, and the configuration of the oxygen electrode lead-out region 10e may be applied to the hydrogen electrode side.

### 1.1.4. Action, Etc.

According to the water electrolysis cell 10, for example, it acts as follows. When pure water is supplied from the oxygen electrode side inlet manifold 14d, pure water reaches the water electrolysis region 10a through the oxygen electrode introduction region 10b and the oxygen electrode introduction side distribution region 10c In the water electrolysis area 10a, pure water (H₂O) supplied from the water supply channel 14a to the anode (oxygen generation electrode) is decomposed into oxygen, electrons and protons (H+) in the anode catalyst layer 12 having a potential by energizing between the anode and the cathode. At this time, protons pass through the solid polymer electrolyte membrane 11 and move to the cathode catalyst layer 15 On the other hand, electronics separated by the anode catalyst layer 12 pass through an external circuit and reach the cathode catalyst layer 15 Then, protons receive electronics in the cathode catalyst layer 15, hydrogen (H₂) is generated, and reaches the cathode gas diffusing layer 16 Incidentally, in the cathode gas diffusion layer 16 accompanied water is present together with the generated hydrogen gas.

Hydrogen gases and associated water present in the cathode gas diffusion 16 reaches the cathode separator 17, flows through the flow path 17a and is discharged from the hydrogen electrode outlet side distribution region (not shown) and the hydrogen electrode outlet manifold 14f (hydrogen electrode outlet hole) through the hydrogen electrode outlet region.

On the other hand, the oxygen generated in the anode catalyst layer 12 and the unused residual water return to the anode separator 14 and are discharged from the oxygen electrode outlet manifold 14e through the hydrogen supply channel 14a through the oxygen electrode lead-side distribution region 10d and the oxygen electrode lead-out region 10e.

### 1.2. Water Electrolysis Stack

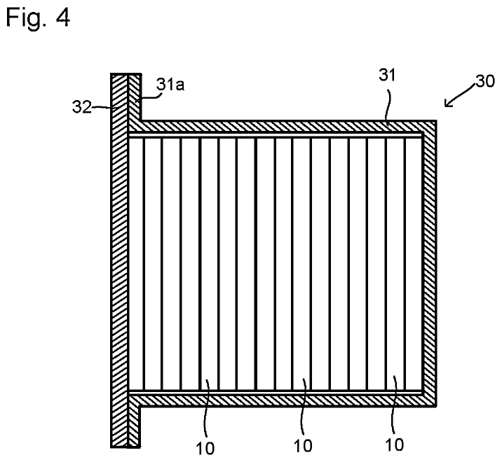

The water electrolysis stack 30 is a member formed by stacking a plurality of (about 50 sheets to about 400 sheets) of the above-described water electrolysis cells 10, and energizes the plurality of water electrolysis cells 10 to generate hydrogen and oxygen. FIG. 4 shows the outline of the structure. The water electrolysis cell 30 includes a stack case 31, an end plate 32, and a plurality of water electrolysis cells 10

Stack case 31, a plurality of water electrolysis cells 10 stacked, and a housing for housing the biasing member 33 inside. Stack case 31 in the present embodiment is open at one end in a rectangular tubular shape, together with the other end is closed, the plate-shaped piece on the opposite side to the opening along the edge of the opening overhangs, to form a flanged 31a.

End plate 32 is a plate-like member, closes the opening of the stack case 31, and has a manifold connecting portion of the oxygen-hydrogen outlet portion. End plate 32 so as to cover the stack case 31 by bolts and nuts or the like overlapping part of the flanged 31a of the stack case 31 is fixed to the stack case 31.

Incidentally, a plurality of water electrolysis cells 10 stacked are sandwiched between the end plate 32 and the stack case 31 from both ends in the stacking direction. The portion disposed in the stacking direction end portion of the water electrolysis cell of the stack case also functions as an end plate, the laminate of the plurality of water electrolysis cells 10 according to this will be sandwiched by the stacking direction both ends by the end plate.

The water electrolysis cell 10 is as described above. A plurality of such water electrolysis cells 10 are overlapped. Here, in this form, as can be seen from FIG. 4, the water electrolysis cell 10 is configured to be overlapped horizontally, the water electrolysis cell 10 is arranged so that the direction in which the water supply flow path 14a are aligned and the direction in which the flow path 17a are aligned are the vertical direction as shown in FIG. 1.

In addition, a flow path for supplying water is formed by overlapping the oxygen electrode side inlet manifold 14d of the respective water electrolysis cells, and a flow path for discharging oxygen and residual water is formed by overlapping the oxygen electrode side outlet manifold 14e, and a flow path for discharging hydrogen and accompanying water is formed by overlapping the hydrogen electrode side outlet manifold 14f.

A biasing member (not shown) for pressing the laminate of the water electrolysis cell in the stacking direction as required may be provided. The biasing member fits inside the stack case 31 and imparts a pressing force to the stack of water electrolysis cells 10 in the stacking direction thereof. Examples of the biasing member may include a dish spring.

### 2.2. Stacking Structure of the Water Electrolysis Cell

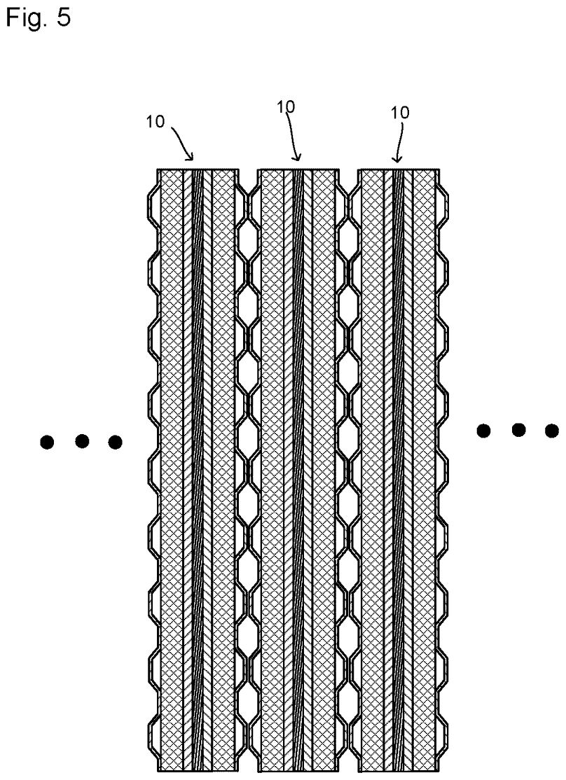

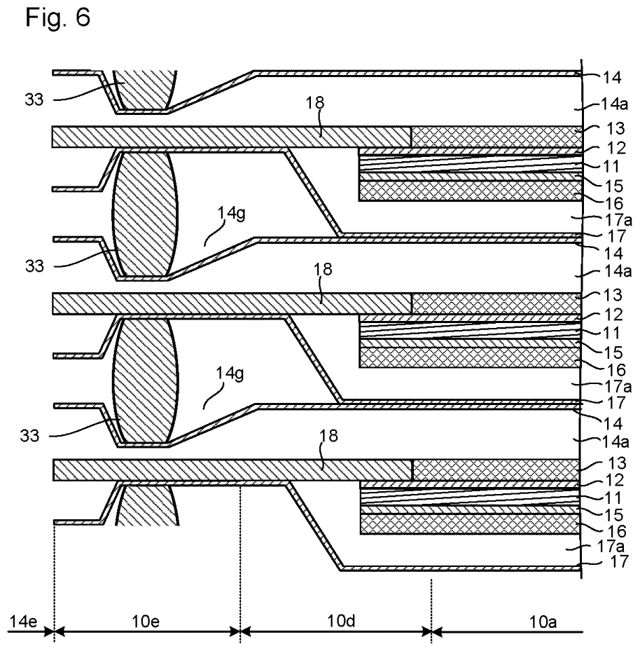

As described above, in the water electrolysis stack 30, a plurality of water electrolysis cells 10 are laminated. In FIG. 5, three of the laminated water electrolysis cells 10 were extracted to represent a cross section of a part of the water electrolysis area 10a. In FIG. 6, three of the laminated water electrolysis cell was extracted to represent a section of a portion of the end portion (the oxygen electrode leading-side distribution region 10d, and the site 10e the oxygen electrode leading-out region).

As can be seen from FIGS. 5 and 6, when the water electrolysis cell 10 is stacked, the cathode separator 17 of one water electrolysis cell 10 and the anode separator 14 of the other water electrolysis cell 10 overlap each other in the adjacent water electrolysis cell 10 More specifically, the convex 17b of the cathode separator 17 of one water electrolysis cell 10 and the convex 14b of the anode separator 14 of the other water electrolysis cell 10 are contacted and overlapped with each other.

Further, as can be seen from FIG. 6, the intercell sealing member 33 is disposed between the adjacent water electrolysis cells 10 among the ends of the water electrolysis cells 10 (the squeezed portion 14g in the present embodiment). This intercellular sealing member 33 seals to prevent leakage of fluid from the manifolds described above.

### 2. Water Electrolysis Stack of the Present Disclosure

### 2.1. Form 1

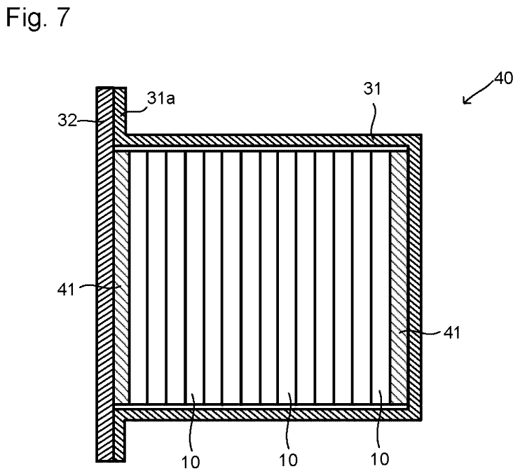

FIG. 7, a diagram illustrating a water electrolysis stack 40, which is an example of one form according to the water electrolysis stack of the present disclosure, is shown. FIG. 7 is a view from the same viewpoint as in FIG. 4. Water electrolysis stack 40 according to the first embodiment as can be seen from FIG. 7, in addition to the water electrolysis stack 30, the sealability improving stacking member 41 to each of the stacking direction end portion of the plurality of water electrolysis cells 10 are stacked one or more. Water electrolysis stack 40, except for the sealability improving stacking member 41 can be considered the same manner as the water electrolysis stack 30 will not be described with the same reference numerals here.

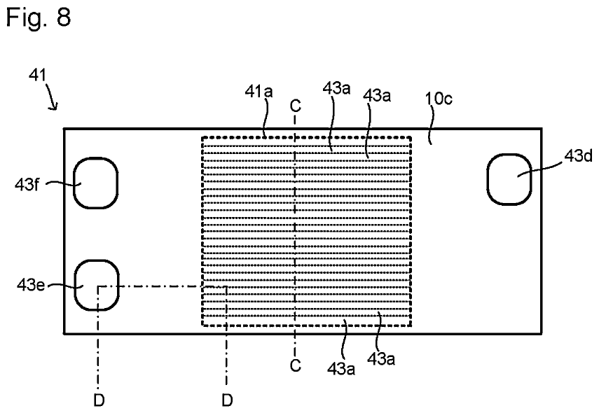

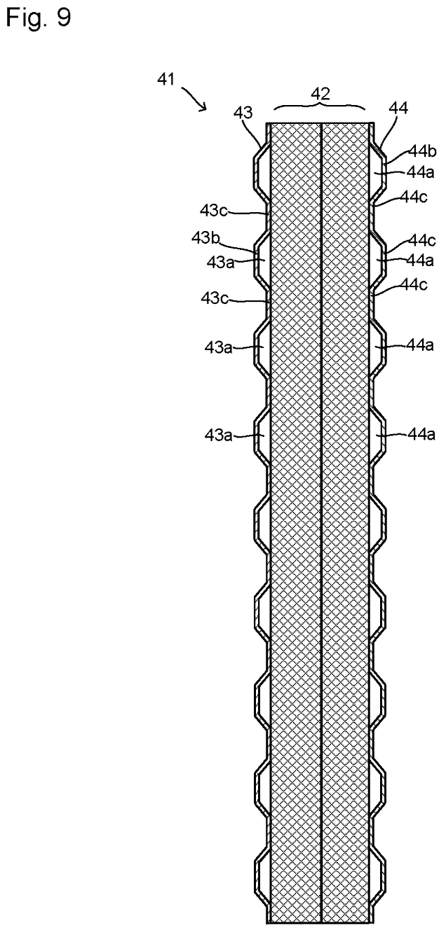

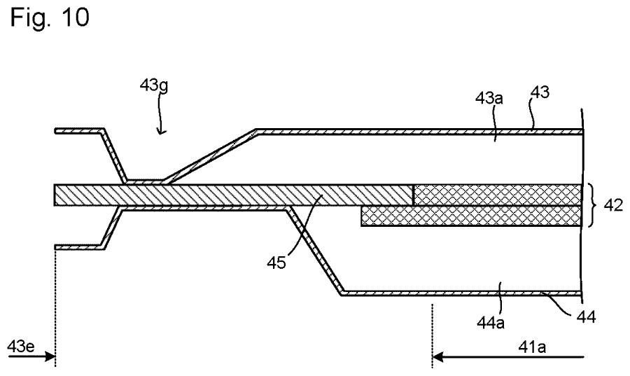

FIG. 8 to 10 shows a diagram for explaining the configuration of the sealability improving stacking member 41 included in the present embodiment. FIG. 8 is a plan view of the lamination member 41 for improving the sealability (the stacking direction of the water electrolysis cell 10 is viewed from the direction of the paper surface back/front). FIG. 9 is a cross section of the site shown in C-C in FIG. 8. FIG. 10 is a cross section of the site shown in D-D in FIG. 8. As can be seen from FIG. 8 to FIG. 10, the laminate member 41 for improving sealability in the present embodiment has a form similar to the water electrolysis cell 10 described above, and the outer shape thereof is generally the same as the water electrolysis cell 10. However, the sealability improving stacking member 41 is not intended to water electrolysis here, the supply water on the inner side is configured so as not to flow.

Sealability improving stacking member 41 is made of a plurality of layers, the core member 42, the first outer plate 43, the second outer plate 44, and has a frame 45.

### 2.1.1. Aspect of Each Layer

Each layer provided in the laminate member 41 for improving sealability has, for example, the following aspect.

### Core Material

Core member 42 is disposed between the first cover 43 and the second cover 44, a plate-shaped member serving as the core of the sealability improving stacking member 41. The material constituting the core material 42 is not particularly limited as long as it has conductivity and has a strength and cushioning property of a certain degree or more. In this form, the cathode gas diffusion layer 16 described above from these viewpoints is laminated so as to be a 2 layer.

The thickness of the core material 42 is preferable about the same thickness as the stack disposed between the anode separator 14 and the cathode separator 17 in the water electrolysis cell 10 from the viewpoint of transmission of conductivity and load.

### First Outer Body

The first exterior body 43 is a plate-like member having a form similar to that of the anode separator 14 described above. Therefore, the first exterior body 43 in the present embodiment is a member unevens are repeated by forming a plate-like member in a wavy shape in the region 41a where the core material 42 is disposed, the recess 43c is disposed in contact with the core material 42, a cavity 43a is formed between the core material 42 and the convex portion 43b.

The first exterior body 43 can be manufactured by press-molding, for example, a titanium-thin film in the same manner as the anode separator 14, and the plate thickness thereof can be made 0.1 mm˜0.2 mm, and the height of the unevenness can be about 0.5 mm.

Further, the first exterior body 43, the first hole 43d corresponding to the oxygen electrode side inlet manifold 14d described above, the second hole 43e corresponding to the oxygen electrode side outlet manifold 14e, and the third hole 43f corresponding to the hydrogen electrode side outlet manifold 14f is provided. These holes, when the sealing property improving stack member 41 is laminated in the water electrolysis cell 10 overlaps the corresponding manifold.

Further, as shown in FIG. 10, the first exterior body 43 in this form, the squeezed portion 43g is provided so as to be convex toward the frame 45.

In addition, in the laminated member 41 for improving sealability, there is no intention of causing water electrolysis here as described above, and since water does not need to be supplied to the inside thereof, there is no region corresponding to the oxygen electrode lead-out side distribution region 10d and the oxygen electrode lead-out region 10e consecutive thereto, which is provided in the anode separator 14, and is sealed so as to be in contact with the frame 45.

### Second Outer Body

The second exterior body 44 is a plate-like member having the same form as the cathode separator 17 described above. Therefore, the second exterior body 44 in the present embodiment is a member unevens are repeated by forming a plate-like member in a wavy shape in the region 41a in which the core material 42 is disposed, the recess 44c is disposed in contact with the core material 42, a cavity 44a is formed between the core material 42 and the convex portion 44b.

The second exterior body 43, for example, can be produced by press-molding a titanium thin film in the same manner as the anode separator 14, the plate thickness can be 0.1 mm˜0.2 mm, the height of the unevens can be about 0.5 mm.

Also, the second exterior body 43, the first hole corresponding to the oxygen electrode side inlet manifold 14d described above, the second hole corresponding to the oxygen electrode side outlet manifold 14e, and the third hole corresponding to the hydrogen electrode side outlet manifold 14f (both not shown) is provided. These holes, when the sealing property improving stack member 41 is laminated in the water electrolysis cell 10 overlaps the corresponding manifold.

In addition, in the laminated member 41 for improving sealability, there is no intention of causing water electrolysis here as described above, and since it is not necessary to supply water to the inside thereof, there is no hydrogen electrode lead-out side distribution region (not shown) and a hydrogen electrode lead-out region (not shown) continuous therewith, which is provided in the cathode separator 17, and is sealed so as to be in contact with the frame 45

### Frame

Frame 45 functions as a sealing member for sealing the inner is disposed between the first cover 43 and the second cover 44 in the outer peripheral portion of the sealability improving stacking member 41.

Accordingly, the frame 45 is disposed and bonded so as to be sandwiched between the first cover 43 and the second cover 44 at the outer peripheral portion of the laminate member 41 for improving sealability.

Frame 45, for example, in the cross section of FIG. 10, between the second hole 43e from the region 41a core 42 is disposed, the first exterior body 43 is in contact with one surface, the second exterior body 44 is in contact with the other surface, sealed.

The frame 45 is made of a thermoplastic resin material having electrical insulation and airtightness and having a relatively high melting point. Such materials may include engineering plastics. Examples of the engineering plastic include a polyethylene naphthalate-based resin (PEN), a polyphenylene sulfide resin (PPS), and a polyphenylsulfone resin (PPSU)

The thickness of the frame is not particularly limited, but is preferably 0.05 mm or more and 0.25 mm or less.

Frame 45 has an adhesive disposed on the front and back thereof, it is adhered to the portion of the first cover 43 and the second cover 44 in contact therewith.

### 2.1.2. Layer Configuration of the Region in Which the Core Material is Disposed

Layered configuration of the region 41a in which the core member 42 is disposed, as shown in FIG. 9, the first cover 43 on one surface of the core member 42, the second cover 44 is disposed on the other surface. Then, a cavity 43a is formed between the first exterior body 43 and the core material 42, and a cavity 44a is formed between the second exterior body 44 and the core material 42.

### 2.1.3. Composition of Other Regions

In other regions, since the laminate member 41 for improving sealability is not intended to perform water electrolysis on the inside thereof as described above, since it is not necessary to supply water to the inside, as shown in FIG. 10, the first exterior body 43 and the second exterior body 44 are sealed in contact with the frame 45.

### 2.1.4. Effect, Etc.

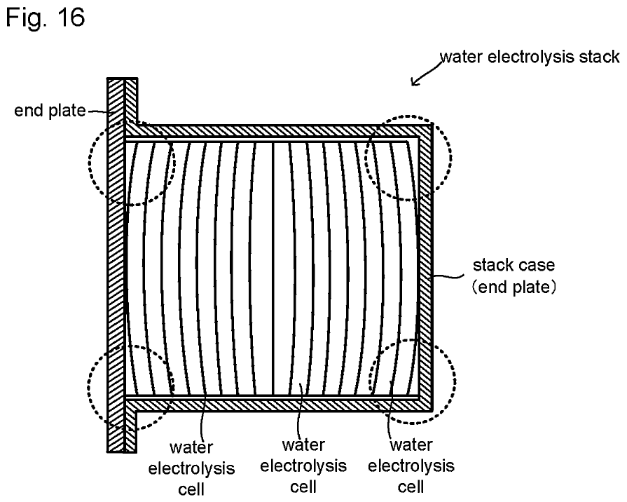

According to the water electrolysis stack 40 provided with the laminated member 41 for improving the sealing property as described above, as described with reference to FIG. 16, the central portion bulges in a plurality of water electrolysis cells disposed between the end plates, warpage is increased in the water electrolysis cell disposed most end plate side, the sealing property disposed at the end there is a possibility that is reduced. In contrast, in the laminated member 41 for sealing property improvement, which is not intended for water electrolysis and water for water electrolysis is not supplied, if replacing the site having the largest warpage, the water electrolysis cell having a large deformation (warpage) can be reduced, it is possible to suppress a decrease in sealability in the water electrolysis stack. Since it is possible to suppress the decrease in sealability, it is possible to suppress the occurrence of leakage and also to increase the hydrogen pressure.

In the above, the laminated member 41 for improving sealability one by one is disposed at both ends in the stacking direction of the water electrolysis cell 10, but the present invention is not limited thereto, and any one of them may be used, or 3 or more laminated members 41 for improving sealability may be disposed. In this case, since the warpage becomes larger as the side closer to the end plate as described above, it is preferable to dispose the laminated member 41 for improving the sealing property at a portion close to the end plate.

### 2.1.5. Modification

A modification will be described below. Since it is a modification of the form of the stack member 41 for improving the sealing property, only described laminated member 41 for improving the sealing property, the description of the other members will be omitted.

In the stack member 41 for improving sealability, since the inside thereof is sealed by the frame 45 as described above, a gas sealed in the inner 14a or the cavity 17a may expand due to a load or heat, and a load may be applied to the laminated member 41 for improving sealability at that pressure. Therefore, in a modification, the cavity 14a and the cavity 17a is provided with a communicating hole communicating with the outside. The communicating holes allow the gas to escape from the cavity 14a and the cavity 17a to reduce the pressure (burden).

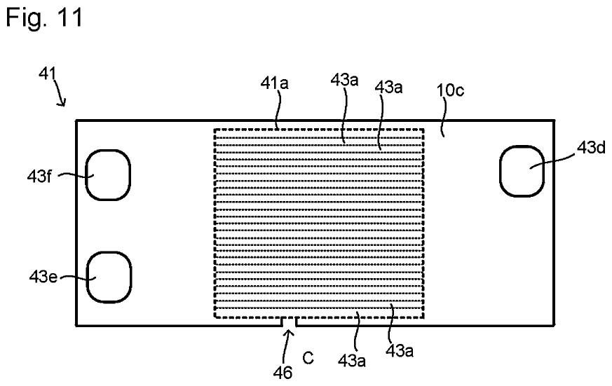

FIG. 11 is a diagram showing a modification 1. In this modification, a notch 46 is provided in at least one of the first exterior body and the second exterior body as a communicating hole in the area 41a in which the core material is disposed, and the cavity 14a and the cavity 17a and the outside are communicated with each other via the notch 46

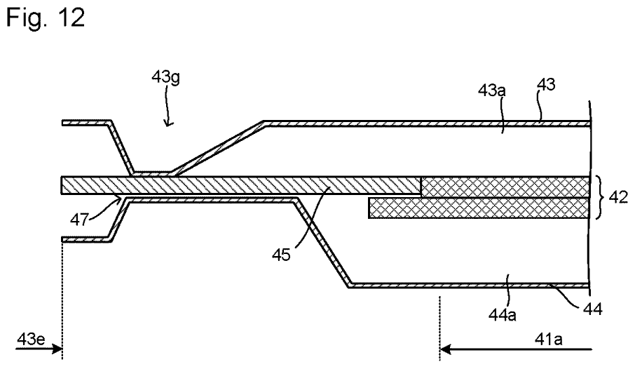

FIG. 12 is a diagram showing a modification 2. In this modification, a portion 47 which does not adhere the frame 45 and the second exterior body 44 at a portion of the surface of the frame 45 which is in contact with the second exterior body 44 is provided. This non-adhesive portion 47 functions as a communicating hole, and communicates the cavity 14a, the cavity 17a, and the outside.

Although a communicating hole formed between the frame 45 and the second exterior body 44 has been described here, a communicating hole may be formed between the frame and the first exterior body in accordance with (or instead of) this.

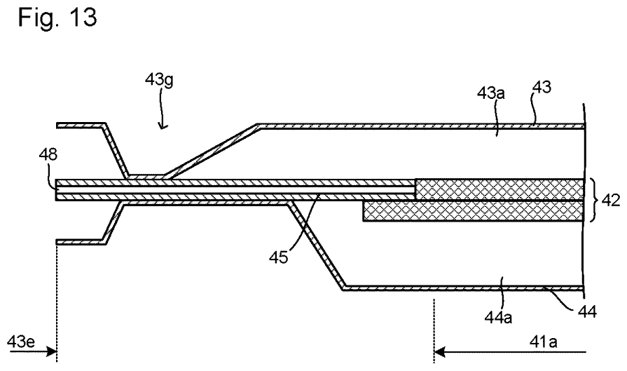

FIG. 13 is a diagram showing a modification 3. In this modification, a hole 48 for communicating the inside and outside of the sealability improving stacking member 41 in a part of the frame 45. This hole 48 functions as a communicating hole, and communicates the cavity 14a, the cavity 17a, and the outside.

### 2.2. Form 2

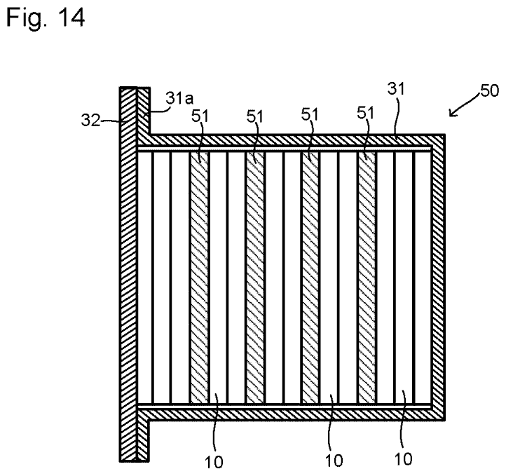

FIG. 14 illustrates a diagram illustrating a water electrolysis stack 50, which is an example of one form according to the water electrolysis stack of the present disclosure. 14 is a view from the same viewpoint as in FIG. As can be seen from FIG. 14, in the water electrolysis stack 50 according to Form 2, in addition to the water electrolysis stack 30, a laminated member 51 for improving sealability is laminated between a plurality of water electrolysis cells 10 Water electrolysis stack 50, except for the sealability improving stacking member 51 can be considered the same manner as the water electrolysis stack 30 will not be described with the same reference numerals here.

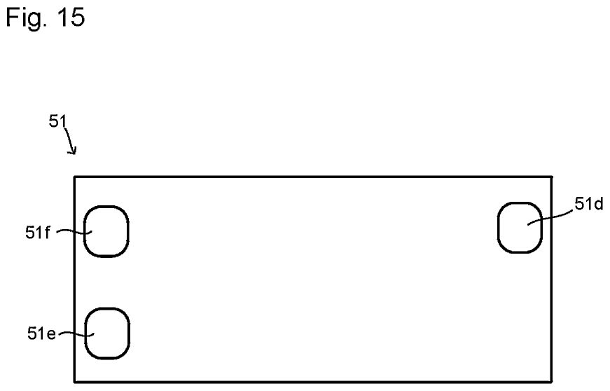

FIG. 15 shows a diagram for explaining the configuration of the sealability improving stacking member 51 included in the present embodiment. FIG. 15 is a plan view of the lamination member 51 for improving the sealability (the stacking direction of the water electrolysis cell 10 is viewed from the direction of the paper surface back/front). The sealability improving stacking member 51 in this form is a plate-like member.

The tabular material constituting the laminated member 51 for improving sealability has conductivity, and is not particularly limited as long as it is a material which is harder to bend than the water electrolysis cell, and examples thereof include stainless steel. Although there is no particular limitation on the plate thickness thereof, it is preferable to have the same level as that of the water electrolysis cell 10, and examples thereof include 0.8 mm or more and 1.5 mm or less. The bending difficulty can be contrasted by the bending test.

In addition, the laminated member 51 for improving sealability is provided with a first hole 41d corresponding to the oxygen electrode side inlet manifold 14d described above, a second hole 51e corresponding to the oxygen electrode side outlet manifold 14e, and a third hole 51f corresponding to the hydrogen electrode side outlet manifold 14f These holes, when the sealing property improving stack member 51 is laminated in the water electrolysis cell 10 overlaps the corresponding manifold.

Although there is no particular limitation on the number and position of the stack members 51 for improving sealability to be arranged, it is preferable that a plurality of laminated members 51 for improving sealability are arranged at predetermined intervals.

According to the water electrolysis stack 50 provided with the laminated member 51 for improving the sealing property as described above, as described with reference to FIG. 16, the central portion bulges in a plurality of water electrolysis cells disposed between the end plates, warpage is increased in the water electrolysis cells disposed most end plate side, the end there is a possibility that the disposed sealing property is lowered. In contrast, by the laminated member 51 for improving the sealing property is not intended for water electrolysis, hardly deformed (strength, high rigidity) water for water electrolysis is not supplied, deformation (warpage) is large water electrolysis cell it is possible to reduce, it is possible to suppress a decrease in sealing property in the water electrolysis stack. Since it is possible to suppress the decrease in sealability, it is possible to suppress the occurrence of leakage, and it is also possible to mention the hydrogen pressure.

### REFERENCE SIGNS LIST

10 . . . Water electrolysis cell, 10a . . . electrode oxygen inlet region, 10b . . . electrode oxygen inlet side distribution region, 10d . . . electrode oxygen outlet side distribution region, 10e . . . electrode oxygen outlet region, 11 . . . solid polymer electrolyte membrane, 12 . . . anode catalyst layer, 13 . . . anode gas diffusion layer (oxygen electrode gas diffusion layer), 14 . . . anode separator (oxygen electrode separator), 14a . . . supply flow path, 14d . . . oxygen electrode side inlet manifold (oxygen electrode outlet hole), 14f . . . hydrogen electrode side outlet manifold (hydrogen electrode outlet hole), 15 . . . cathode catalyst layer, 16 . . . cathode gas diffusion layer (hydrogen electrode gas diffusion layer), 17 . . . cathode separator (hydrogen electrode separator), 18 . . . frame, 30, 40, 50 . . . water electrolysis stack, 41, 51 . . . laminated member for improving the sealing property

1. A water electrolysis stack configured by stacking a plurality of water electrolysis cells to generate hydrogen by supplying water and electric power to the water electrolysis cells, the water electrolysis stack comprising:
a sealability improving stacking member stacked on a predetermined location on or in the stacked water electrolysis cells, the water being not introduced into the sealability improving stacking member.

2. The water electrolysis stack according to claim 1, wherein
the sealability improving stacking member comprises:
a first cover having the same shape as an anode separator included in the water electrolysis cells;
a second cover having the same shape as a cathode separator included in the water electrolysis cells;
a core material disposed between the first and second covers; and
a frame disposed between the first and second covers, the frame adhering the first and second covers.

3. The water electrolysis stack according to claim 2, comprising:
a communicating hole allowing a space between the first and second covers, and an outside to communicate.

4. The water electrolysis stack according to claim 3, wherein
the communicating hole is provided in at least one of the first and second covers.

5. The water electrolysis stack according to claim 3, wherein
the communicating hole is provided in the frame.

6. The water electrolysis stack according to claim 3, wherein
the communicating hole is formed between the first or second cover, and the frame.

7. The water electrolysis stack according to claim 2, wherein
the core material is made of the same material as a cathode gas diffusion layer of the water electrolysis cells.

8. The water electrolysis stack according to claim 1, wherein
the sealability improving stacking member is disposed on an end portion of a stack formed of the water electrolysis cells.

9. The water electrolysis stack according to claim 1, wherein
the sealability improving stacking member is a plate-like member that is more difficult to bend than the water electrolysis cells.

10. The water electrolysis stack according to claim 9, wherein
a plurality of the sealability improving stacking members are disposed between a plurality of the water electrolysis cells.
